(19) United States
(12) Patent Application Publication
(10) Pub. No.: US 2023/0139941 A1
(43) Pub. Date: May 4, 2023

(54) METHOD OF SEQUESTERING GAS-PHASE MATERIALS DURING FORMATION OF HEMPCRETE AND MATERIALS FORMED USING SAME

(71) Applicant: The Regents of the University of Colorado, a body corporate, Denver, CO (US)

(72) Inventors: Wilfred V. Srubar, III, Boulder, CO (US); Joseph Hoberg Arehart, Boulder, CO (US)

(73) Assignee: The Regents of the University of Colorado, a body corporate, Denver, CO (US)

(21) Appl. No.: 17/918,546

(22) PCT Filed: Apr. 15, 2021
(86) PCT No.: PCT/US21/27525

§ 371 Date: Oct. 12, 2022

Related U.S. Application Data
(60) Provisional application No. 63/010,537, filed on Apr. 15, 2020.

(51) Int. Cl. C04B 40/02; C04B 28/12; C04B 14/10; C04B 18/14; C04B 18/24; C04B 41/00; C04B 40/00

(52) U.S. Cl. CPC C04B 40/02; C04B 28/12; C04B 14/106; C04B 18/141; C04B 18/248; C04B 41/0072; C04B 40/0089; C04B 2103/0088

(57) ABSTRACT

A method of sequestering gas-phase materials, hempcrete formed using the method, and methods of using hempcrete are disclosed. An exemplary method includes providing a mixture of hempcrete compound material within a chamber and exposing the mixture within the chamber to a gas for a period of time to form hempcrete, wherein the hempcrete exhibits net-negative life cycle carbon emissions. A model to predict net life cycle carbon emission of hempcrete is also disclosed.

### CROSS-REFERENCE TO RELATED APPLICATIONS

This application claims the benefit of U.S. Provisional Application Ser. No. 63/010,537 filed Apr. 15, 2020, entitled METHOD OF SEQUESTERING GAS-PHASE MATERIALS DURING FORMATION OF HEMPCRETE AND MATERIALS FORMED USING SAME, the contents of which are hereby incorporated herein by reference, to the extent such contents do not conflict with the present disclosure.

### BACKGROUND OF THE DISCLOSURE

Hempcrete is a natural insulation material that exhibits favorable thermal properties and low manufacturing emissions. Hempcrete is a biocomposite, comprising hemp shiv and a lime-based binder composed of hydrated lime and either a hydraulic (e.g., natural hydraulic lime and ordinary portland cement) or pozzolanic binder (e.g., metakaolin). While traditional hempcrete can exhibit desirable properties—e.g., for use on construction, it is generally desired to use construction materials that mitigate carbon emission and/or that can store carbon. Accordingly, improved hempcrete (e.g., that stores additional carbon), improved methods of forming improved hempcrete (e.g., that increase or optimize carbon storage), and methods of using the improved hempcrete are desired.

Any discussion, including discussion of problems and solutions, set forth in this section, has been included in this disclosure solely for the purpose of providing a context for the present disclosure, and should not be taken as an admission that any or all of the discussion was known at the time the invention was made or otherwise constitutes prior art.

### Summary of Disclosure

Various embodiments of the present disclosure relate to methods of sequestering gas-phase materials in or during the formation of hempcrete, to the hempcrete formed using such methods, and to methods of using the hempcrete. While the ways in which embodiments of the disclosure address the shortcomings of traditional hempcrete are discussed in more detail below, in general, embodiments of the disclosure provide methods of forming hempcrete which are significantly carbon negative. Further examples of the disclosure provide models for predicting and optimizing carbon storage of hempcrete.

In accordance with examples of the disclosure, a method of sequestering gas-phase materials is provided. The method includes providing a mixture of hempcrete compound material within a chamber and exposing the mixture within the chamber to a gas comprising the gas-phase materials for a period of time to form hempcrete, wherein the hempcrete exhibits net-negative life cycle carbon emissions. In accordance with at least one example, the step of exposing comprises carbonizing the mixture. The mixture can include, for example, one or more of agricultural waste, of hemp shiv, hemp fiber, rice husk (hulls), flax shiv, rapeseed, biochar, wood fiber, and/or plant fiber, slag, or the like. The hempcrete can exhibit net-negative life cycle carbon emissions of about −51 kg CO₂e/m³ or less (more negative) or −42 kg CO₂e/m³ or less. The gas can include, for example, one or more of flue gas, direct capture gas from cement production, and carbon capture from bioenergy production. The hempcrete can include a binder, such as a binder comprising a lime-based binder composed of hydrated lime and either a hydraulic (e.g., natural hydraulic lime and ordinary portland cement) or pozzolanic binder (e.g., metakaolin). An amount of binder in the mixture can be greater than or equal to 30 wt %, is greater than or equal to 40 wt %, or greater than or equal to 50 wt %. The hempcrete can have any suitable form, such as prefabricated blocks or panels. In accordance with further examples, the method can include the steps of encapsulating the hempcrete or the mixture (e.g., in a sealable material, such as a plastic pouch) and applying a vacuum to the encapsulated hempcrete or mixture. Removing some of the air that is otherwise present in the hempcrete is thought to reduce a thermal conductivity of the hempcrete.

In accordance with additional examples of the disclosure, hempcrete that is formed with net-negative life cycle carbon emissions is provided. The hempcrete can be formed using a method as described herein. In accordance with further examples of the disclosure, the hempcrete can include one or more of a phase change material (e.g., a paraffin), an expanded aggregate (e.g., perlite), and/or a thin-membraned balloon—e.g., filled with air or other gas—to, for example, lower a thermal conductivity of the hempcrete.

In accordance with yet further examples of the disclosure, a method of using the hempcrete (e.g., formed using a method as described herein) is provided.

These and other embodiments will become readily apparent to those skilled in the art from the following detailed description of certain embodiments having reference to the attached figures; the invention not being limited to any particular embodiment(s) disclosed.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates system boundary of the hempcrete LCA. Life cycle stages A1-A3 represent material extraction and manufacturing emissions (including biogenic carbon storage), while use-phase (B1) represents the carbon uptake via carbonation.

FIG. 2 illustrates effects of binder composition on the theoretical CO₂ storage potential (per mass of binder) for exemplary hempcrete mixtures.

FIG. 3 illustrates effects of hempcrete density on the theoretical carbon uptake of hempcrete via carbonation for three different hydraulic binder concentrations (a) high, (b) mid, and (c) low.

FIG. 4 illustrates a comparison of carbonation models on theoretical estimates of carbon uptake via carbonation of different hempcrete formulations: (a)-(c) Very Light, (d)-(f) Light, (g)-(i) Medium, and (j)-(l) Heavy densities.

FIG. 5 illustrates life cycle GWP (kgCO₂e) for each hempcrete mixture of hydraulic and pozzolanic binders: (a)-(c) natural hydraulic lime, (d)-(f) ordinary portland cement, and (g)-(i) metakaolin.

FIG. 6 illustrates effect of carbonation model on LCA results for GWP medium density natural hydraulic lime with mid concentration of hydraulic binder in accordance with at least one example of the disclosure.

FIG. 7 illustrates effects of carbonation model on LCA results for GWP medium density natural hydraulic lime with mid concentration of hydraulic binder in accordance with at least one example of the disclosure.

FIG. 8 illustrates a method in accordance with examples of the disclosure.

FIG. 9 illustrated hempcrete in accordance with examples of the disclosure.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

In this disclosure, the term gas may include material that is a gas at normal temperature and pressure, a vaporized solid and/or a vaporized liquid, and may be constituted by a single gas or a mixture of gases, depending on the context. Further, in this disclosure, any two numbers of a variable can constitute a workable range of the variable, and any ranges indicated may include or exclude the endpoints. Additionally, any values of variables indicated (regardless of whether they are indicated with “about” or not) may refer to precise values or approximate values and include equivalents, and may refer to average, median, representative, majority, etc. in some embodiments. Further, in this disclosure, the terms “including,” “constituted by” and “having” can refer independently to “typically or broadly comprising,” “comprising,” “consisting essentially of,” or “consisting of” in some embodiments. In accordance with aspects of the disclosure, any defined meanings of terms do not necessarily exclude ordinary and customary meanings of the terms.

Examples of the disclosure relate to methods of sequestering gas-phase materials, to hempcrete—e.g., formed using a method as described herein, and to methods of using such hempcrete. The hempcrete and methods described herein can be used for long-term carbon storage, which can be achieved, for example, via utilization of hemp shiv and/or other material in hempcrete. Additional carbon storage can be achieved via carbonation of a hempcrete binder throughout the useful life of hempcrete.

A comprehensive theoretical model based on cement and carbonation chemistry, formulated to quantify the total theoretical in situ CO₂e sequestration potential of hempcrete binders, is provided below. As discussed below, to estimate the percentage of manufacturing CO₂e emissions that can be recovered through in situ binder carbonation, the model is implemented in life cycle assessments of 36 hempcrete formulations of various binder contents and densities using an equivalent functional unit (FU) of a 1 m² wall assembly with a U-value of 0.27 W/(m²K). The model estimates between 18.5% and 38.4% of initial carbon emissions associated with binder production can be sequestered through in situ carbonation. Additionally, a net life cycle CO₂e emissions of hempcrete can be negative, with a minimum of −16.0 kg CO₂e/FU for the hempcrete mixture formulations considered herein. However, it is estimated that some hempcrete formulations can exhibit net-positive emissions, especially high-density mixes (>300 kg/m³) containing portland cement, thereby illustrating the importance of materials selection and proportioning of low-carbon hempcrete.

Hempcrete, also referred to as hemp-lime concrete or a hemp-lime biocomposite, is a composite material that generally includes hemp shiv (i.e., hemp hurd) from the hemp plant and a lime-based binder. A byproduct of hemp fiber production, hemp shiv is the woody core of a hemp plant. The composition of the lime-based binder can vary, for example, based upon desired mechanical and physical properties (e.g., density), but typically includes of hydrated lime with natural hydraulic lime (NHL) or ordinary portland cement (OPC). Hydraulic binders are used with regular hydrated lime to accelerate the set time of hempcrete, as regular limes take weeks to months to gain adequate strength. Pozzolans, such as metakaolin and ground granulated blast furnace slag, can be used as additional or alternative binders to reduce the global warming potential (GWP) of hempcrete, while preserving its favorable thermal, moisture, and mechanical properties.

Hempcrete is primarily used as an insulation material for its low thermal conductivity, rather than as a structural or load-bearing material, given its lower strength relative to other construction materials. Two primary construction techniques are used—one, using forms to cast or spray hempcrete directly in place on the construction site and the second, using prefabricated blocks that are transported and installed on-site using methods akin to masonry construction. Hempcrete insulation (in either sprayed or block form) is typically coupled with light-frame timber construction in residential buildings. After mixing, fresh hempcrete can be sprayed (or blocks are laid) between framing members. After installation, finishes and weathering coatings, such as drywall or plasters, can then applied for aesthetics and increased durability.

By definition, carbon-negative materials store more carbon dioxide equivalent (CO₂e) than they emit over their life cycle. Life cycle assessments (LCAs) of hempcretes have been conducted to quantify their environmental impacts. Researchers have estimated net life cycle CO₂e emissions of hempcrete from −1.6 to −79 kg CO₂e/m² of different wall assemblies, depending on (1) functional unit, (2) expected lifetime, (3) LCA methodology (including system boundary assumptions and inclusion or exclusion of biogenic carbon storage), and (4) expected contributions to overall carbon negativity by in situ carbonation of cementitious binders beyond cradle-to-gate.

### Carbonation Models for Hempcrete

To estimate carbon sequestration from in situ binder carbonation, LCA practitioners have used manufacturer data or mathematical models for quantifying the uptake. Two models have been previously proposed to account for the uptake of CO₂ by the hydraulic binder component of hempcrete. The first (Model A) assumes that only the hydrated lime— or a small fraction of it—carbonates and neglects any carbonation of the hydraulic. The second (Model B) assumes that all calcium hydroxide, or CH (i.e., portlandite) in cement chemistry notation, in both the hydrated lime and hydraulic binder carbonates. The amount of portlandite (by mass) in hempcrete binders has also been estimated to varying degrees. For example, one estimate assumed that 60% of the hydraulic binder converts to portlandite, while another estimate assumed 75% of the calcium-oxide (CaO) present in the hydraulic binder converts to portlandite.

Table 1 summarizes the previous studies that have accounted for CO₂ uptake of cementitious binders in hempcrete. All studies assume through-thickness carbonation within the lifetime of the hempcrete assembly. For the studies that employed Model A, high variation exists in the reported CO₂ uptake from the binder constituent alone (0.091 to 1.19 kg CO₂/kg binder. Two studies that employed Model B report estimated CO₂ sequestration via hempcrete carbonation between 0.325 to 0.462 kg CO₂/kg binder. While Model A is simple to implement, it only captures the aerial carbonation of the hydrated lime. If hydraulic or pozzolanic binders are used, carbonation of the reaction products is not considered leading to an underprediction of hempcrete's ability to sequester CO₂.

In contrast, Model B generally overpredicts hempcrete's ability to sequester CO₂, as it assumes that all CH present in the binder carbonates, neglecting the consumption of CH during additional hydration or pozzolanic reactions. Both Model A and Model B do not consider the effect that pozzolanic reactions have on the amount of CH, nor do they consider the carbonation of calcium-silica-hydrate (CSH), which can decalcify and carbonate in the presence CO₂.

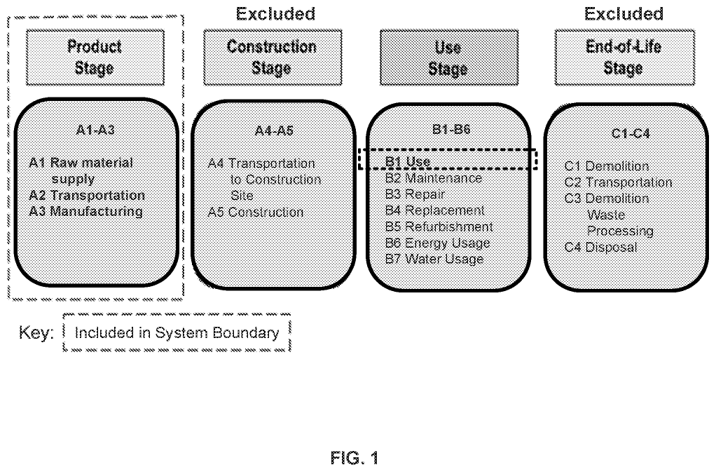

TABLE 1
Summary of hempcrete LCA studies that estimate and report CO₂
sequestration via carbonation. Exemplary hempcrete binders comprise up to three
components that are reported by their contribution to total binder weight. The
CO₂ uptake represent the carbon sequestration that occurs during
LCA stages B2 and C, illustrated in FIG. 1, where negative values represent in
situ carbon sequestration.

| | | | | CO₂ Uptake in |
|---|---|---|---|---|
| | Hydrated | Hydraulic | Pozzolanic | Use (B1) and End |
| | Lime ratio | Binder ratio | Binder ratio | of Life (C) |
| Model | by weight | by weight | by weight | (kg CO₂/kg binder) |
| No | Air Lime | Proprietary | N/A | −0.249 |
| model | 0.8 | Hydraulic | | |
| specified | | binder | | |
| | | 0.2 | | |
| Model A | Hydrated Lime | Natural | Not specified | −0.571 |
| | (CL90S) | Hydraulic Lime | 0.1 | |
| | 0.75 | (NHL5) | | |
| | | 0.15 | | |
| Model A | Not reported | Not reported | N/A | −0.091 |
| Model A | Not reported | Not reported | N/A | −0.700 |
| Model A | Hydrated Lime | OPC | N/A | −1.19 |
| | (Dolomitic) | 0.2 | | |
| | 0.8 | | | |
| Model B | Hydrated Lime | Type 1 CEM | Not specified | −0.462 |
| | 0.75 | 0.15 | 0.1 | |
| Model B | Hydrated Lime | OPC | N/A | −0.325 |
| | (Dolomitic) | 0.2 | | |
| | 0.8 | | | |

As described below, a simple, yet comprehensive, mathematical model based on lime and cement hydration and carbonation chemistry for quantifying the theoretical carbon storage potential of hempcrete has been developed. The model is subsequently implemented in an LCA of a 1 m² hempcrete wall assembly with a constant U-value of 0.27 W/(m²K) to estimate the net life cycle CO₂e emissions of hempcrete and to specifically highlight the potential contribution of in situ carbonation to overall carbon storage potential. The theoretical formulation of the model, as well as the goal and scope of the LCA and results of the LCA, which employs three different carbonation models (i.e., Model A, Model B, and the model proposed herein) are set forth below. In addition, an illustration of how use of different models to predict in situ carbonation can influence the total GWP calculation of hempcrete is provided below.

### Computational Methods

Theoretical Formulation

The theoretical mass of CO₂ that can be stored by hempcrete wall assemblies via in situ carbonation is quantified using principles of cement chemistry. This section first describes the chemical composition of the binders and estimates the total quantities of expected hydration reaction products (i.e., CH and CSH). The anticipated reduction of the total amount of portlandite available for carbonation due to the conversion of portlandite to CSH in the presence of siliceous pozzolans is mathematically accounted for in the model formulation. Lastly, the stoichiometry of carbonation reactions between atmospheric CO₂ and hydration products is used to estimate the theoretical mass of CO₂ that is sequestered via carbonation of the hempcrete binders.

Hempcrete Binder Chemistry

Binders for hempcrete construction primarily include three constituents: hydrated lime, hydraulic binders, and pozzolanic binders. Table 2 summarizes the average chemical and mineral composition of the binders used in hempcrete construction.

Hydrated lime, also known as slaked lime, is composed of 80-90% pure CH. Referred to as aerial lime, hydrated lime hardens and gains strength by reacting directly with CO₂. To accelerate the time aerial limes take to gain strength, hydraulic binders and pozzolanic binders are used in combination with aerial lime to increase early-age mechanical properties of hempcrete. Common hydraulic binders for hempcrete include Type I OPC and natural hydraulic lime (NHL). When OPC and NHL are exposed to water, they react to form portlandite (i.e., CH). However, pozzolanic binders, such as metakaolin, require both water and a source of CH to produce CSH, which also increases the mechanical properties of cementitious materials. Therefore, pozzolanic binders are almost always used in combination with hydraulic binders.

Type I OPC is composed mainly of silicon dioxide (S), aluminum oxide (A), ferric oxide (F), calcium dioxide (C), magnesium oxide (M), sulfur trioxide (Ŝ), and sodium oxide (N). These oxides are the building blocks of four main cementitious minerals present in OPC: tricalcium silicate (C₃S), dicalcium silicate (C₂S), tricalcium aluminate (C₃A), and tetracalcium aluminoferrite (C₄AF). NHL includes C₂S as its primary form of silicates. In addition to C₂S, NHL also contains some hydrated lime. NHL is similar to hydrated lime in that it is primarily composed of portlandite (i.e., CH). NHL is classified into three types based upon its intended use; NHL 2, NHL 3.5, and NHL 5.

TABLE 2
Average chemical and mineral compositions
of hempcrete binder components (by wt. %).

| | | | Type 1 | Natural | |
|---|---|---|---|---|---|
| | | Hydrated | Ordinary | Hydraulic | |
| | | Lime | Portland | Lime | |
| | Chemical | (CL90-S) | Cement | (NHL5) | Metakaolin |
| Chemical | C (CaO) | 65-75 | 63.9 | 50-70 | 0.07 |
| Composition | S (SiO₂) | — | 20.5 | 6-20 | 52.1 |
| | A (Al₂O₃) | — | 5.4 | — | 41.0 |
| | F (Fe₂O₃) | — | 2.6 | — | 4.32 |
| | M (MgO) | — | 2.1 | — | — |
| | \check{S} (SO₃) | — | 3.0 | — | — |
| | N (Na₂O) | — | 0.61 | — | — |
| | Other | 25-35 | 1.9 | 15-20 | — |
| | Source | | (ASTM C150, | ) | |
| | | | 2019) | | |
| Mineral | CH | 80-90 | — | 30-50 | — |
| Composition | | | | | |
| | C₂S | — | 18 | 20-40 | — |
| | C₃S | — | 54 | — | — |
| | C₃A | — | 10 | — | — |
| | C₄AF | — | 8 | — | — |
| | C\tilde{c} (CaCO₃) | 5-10 | — | 5-20 | — |
| | Other | 0-5 | 10 | 0-15 | 100 |
| | Source | | (ASTM C150, | | |
| | | | 2019) | | |

Metakaolin is a common pozzolanic additive composed primarily of three oxides: S, A, and small amounts of F. Metakaolin is a pozzolan that is produced from calcining kaolinite clay at high temperatures. Metakaolin can be used to replace cementitious materials due to its pozzolanic activity when combined with hydraulic binders, such as OPC or NHL.

Hydration Reactions

While hydrated lime (˜80-90% CH) can directly carbonate with atmospheric CO₂, hydraulic binders must first undergo cement hydration reactions to produce CH. The primary hydration reactions of the calcium silicate minerals with water produce CH and CSH, shown in Eqs. 1-4. When NHL, which includes C₂S as a mineral form of calcium and silica, is used as a binder in hempcrete, the only hydration reaction that occurs is shown in Eq. 1, the hydration of C₂S. When OPC is used as a binder, all four hydration reactions occur due to the presence of all minerals in Type I cement:

2C₂S+9H→C₃S₂H₈+CH (1)

2C₃S+11H→C₃S₂H₈+3CH (2)

C₄AF+2CH+14H→C₆(A,F)H₁₃+(F,A)H₃ (3)

C₃A+3CŜH₂+26H→C₆AŜ₃H₃₂ (4)

In cement chemistry (i.e., oxide) notation, water is denoted as H, gypsum as 3CŜH₂, ettringite as C₆AŜH₃₂, calcium aluminoferrite hydrate as C₆(A,F)H₁₃, and aluminoferrite hydrate as (F,A)H₃.

Pozzolanic Reactions

In addition to the hydration reactions, the presence of pozzolans leads to the production of CSH. Siliceous and aluminous materials from SCMs, such as metakaolin, react with available CH, effectively decreasing the amount of CH available for carbonation, as shown by:

3CH+2S+5H→C₃S₂F₁₈ (5)

3CH+A+3H→C₃AH₆ (6)

However, the pozzolanic reaction involving aluminum oxide is not typically considered, as silicates are the main reactive component within most pozzolans. Therefore, reaction (6) is neglected in the proposed model.

Carbonation Reactions

The carbonation of hempcrete can refer to the process in which atmospheric carbon-containing gas, such as carbon dioxide (CO₂) reacts with the binder (i.e., CH and CSH). In general, the carbonation of CH consumes CO₂ and precipitates calcium carbonate (CaCO₃), as described in Eq. 7:

Ca(OH)_{2(aq)}+CO₂→CaCO₃₍ₛ₎+H₂O₍ₗ₎ (7)

The carbonation of CSH can also occur in lime-based binders according to Eq. 8, assuming that CSH takes the simplified form of: CSH=3Ca(OH)₂+SiO₂.

3Ca(OH)_{2(aq)}+SiO₂₍ₛ₎+3CO₂→3CaCO₃₍ₛ₎+SiO₂+3H₂O₍ₗ₎ (8)

Several other compounds in cement paste, such as magnesium oxide and ferric oxide phases, have also been known to undergo carbonation reactions. For the proposed model, however, these reactions are neglected, as they are less significant than the primary carbonation reactions and their mechanisms and extents of reaction in cement paste have not been as thoroughly investigated. Note that the assumption of ignoring these phases will result in a more conservative estimate for the overall CO₂ storage potential of hempcrete via in situ carbonation.

### Carbonation Model

From the hydration and pozzolanic reactions, the theoretical quantity of CO₂ that is sequestered by a specific hempcrete mixture can be calculated according to:

C_{m,CH}=α_{CH}−β_{CH} (8a)

C_{m,CSH}=α_{CSH}+β_{CSH} (8b)

Cₘ=C_{m,CH}+C_{m,CSH}=(α_{CH}+α_{CSH})−(β_{CH}−β_{CSH}) (8c)

where C_{m,CH} and C_{m,CSH} are the total mass quantities of CO₂ that are sequestered by CH and CSH, respectively, in units of kg CO₂/kg of binder paste. α_{CH} and α_{CSH} are the CO₂ storage potential based upon the quantity of CH or CSH, respectively, after the completion of the carbonation (in units of kg CO₂/kg carbonated binder paste). β_{CH} and β_{CSH} are the CO₂ storage potential based upon the quantity of CH or CSH, respectively, after the completion of the pozzolanic and carbonation reactions (in units of kg CO₂/kg carbonated binder paste).

Carbon Storage Potential of the Hydraulic Binder and Hydrated Lime

The carbon storage potentials of the hydraulic binder and hydrated lime are represented by the variables α_{CH} and α_{CSH}, respectively. These variables are computed from the ratio of mineral consumption in the hydration reactions to the CO₂ consumption in the carbonation process scaled by their molecular weights:

$${α}_{CH} = [ {ϕ}_{h} ( \frac{3}{2} \frac{{K}_{{C}_{3} S}}{{MW}_{{C}_{3} S}} + \frac{1}{2} \frac{{K}_{{C}_{2} S}}{{MW}_{{C}_{2} S}} - \frac{2}{1} \frac{{K}_{{C}_{4} AF}}{{MW}_{{C}_{4} AF}} ) + \frac{{K}_{CH}}{{MW}_{CH}} ] * {MW}_{{CO}_{2}} \qquad ( 9 )$$

$${α}_{CSH} = 3 * [ {ϕ}_{h} ( \frac{1}{2} \frac{{K}_{{C}_{3} S}}{{MW}_{{C}_{3} S}} + \frac{1}{2} \frac{{K}_{{C}_{2} S}}{{MW}_{{C}_{2} S}} ) ] * {MW}_{{CO}_{2}} \qquad ( 10 )$$

where ϕₕ is the degree of hydration, K_{C}_{₃}_{S}, K_{C}_{₂}_{S}, K_{C}_{₄}_{AF}, and K_{CH} are concentrations (in decimal form) of C₃S, C₂S, C₄AF, and CH, respectively, and MW_{C}_{₃}_{S}, MW_{C}_{₂}_{S}, MW_{C}_{₄}_{AF}, and MW_{CH} are the molecular weights of C₃S (228.31 g/mol), C₂S (172.24 g/mol), C₄AF (242.98 g/mol) and CH (74.09 g/mol), respectively. The coefficients are stoichiometric ratios derived from Eqs. 1-8 of the CH and CSH produced during the hydration of the hydraulic binder, or initially present in the hydrated lime, to the total estimated quantity of either CH or CSH produced by the hydration reaction. The negative coefficient for C₄AF represents the consumption of CH during hydration, as mathematically described by Eq. 3.

Carbon Storage Potential of the Pozzolanic Binder

With the addition of pozzolanic binders, the available CH is consumed and converted to CSH (Eq. 5). Both CH and CSH carbonate and the total mass of CO₂ consumed during this reaction is represented by β_{CH} and β_{CSH}. These two quantities are computed depending upon which reactant is limiting. To determine which reactant is limiting, the ratio of Eq. 11 should be used:

$$Q = \frac{S}{{α}_{CH} * \frac{{MW}_{CH}}{{MW}_{{CO}_{2}}}} \qquad ( 11 )$$

If Q=0, then there are no silicates (S) present and Eq. 12a is used to compute β_{CH} and β_{CSH}. If Q≥0.5406, then CH is the limiting reactant and Eq. 12b is used to compute β_{CH} and β_{CSH} If Q<0.5406, then S is the limiting reactant, and Eq. 12c calculates the correct values for β_{CH} and β_{CSH}. The value of 0.5406 (g CO₂/g binder) is determined by the stoichiometry and molar ratio of the conversion of CH to CSH to CO₂ denoted by both the pozzolanic and carbonation reaction equations.

$${β}_{CH} = 0 , {β}_{CSH} = 0 \qquad ( 12 a )$$

$${β}_{CH} = {α}_{CH} , {β}_{CSH} = 0.594 * {α}_{CH} * \frac{{MW}_{CH}}{{MW}_{{CO}_{2}}} \qquad ( 12 b )$$

$${β}_{CH} = 1.099 {K}_{S} , {β}_{CSH} = 1.099 {K}_{S} \qquad ( 12 c )$$

When no pozzolans are present in the system (Eq. 12a), β_{CH}=0 and β_{CSH}=0, as expected. Depending upon the silica (S) content of the pozzolan, either CH or S will be the limiting reagent within the pozzolanic reaction (Eq. 5). If CH is limiting (Eq. 12b), then β_{CH}=α_{CH} and

$${β}_{CSH} = 0.594 * {α}_{CH} * \frac{{MW}_{CH}}{{MW}_{{CO}_{2}}} ,$$

where α_{CH} is calculated from Eq. 9. If S is limiting (Eq. 12c), then it is assumed that all of the available silica is converted to CH and CSH, thus β_{CH}=1.099 K_{S} and β_{CSH}=1.099 K_{S}, where K_{S} is the concentration of S. The scalar of 1.099 is determined by calculating the molar ratio of CH or CSH to silica (3 to 2) from Eq. 5, dividing the ratio by the molecular weight of SiO₂ (60.08 g/mol) and multiplying by the molecular weight of CO₂ (44.01 g/mol). Typically, if a pozzolanic binder is used, it is used in small enough quantities such that CH is the limiting reactant and Eq. 12c is employed to calculate the necessary coefficients β_{CH} and β_{CSH}.

Total Carbon Storage Potential of Hempcrete Binders

Cₘ, described by Eq. 8c, represents the total CO₂ uptake in kg per kg of hydrated binder in a hempcrete mixture. To evaluate the carbon storage potential of hempcrete, C_{S}, a mass factor, θ, defined herein as a mass ratio of hydrated binder paste to hempcrete, is required. In addition, since not 100% of the CH or CSH will carbonate, a carbonation factor, ϕ_{C}, is used.

Eq. 13a provides the calculation for the total carbon storage potential of the binder per unit mass of hempcrete, while the contributions of CH and CSH carbonation are detailed by Eqs. 13b and 13c, respectively.

Cₛ=ϕ_{C}*Cₘ*θ (13a)

C_{s,CH}=ϕ_{C}C_{m,CH}*θ (13b)

C_{s,CSH}=ϕ_{C}*C_{m,CSH}*θ (13c)

The proposed model assumes that the entire volume of a hempcrete assembly undergoes the same degree of carbonation within its lifespan. Experimental evidence has informed this assumption. Previous research has shown that after 240 days of exposure at ambient conditions, the degree of carbonation varies with depth, being close to zero below a depth of 6 cm, while under accelerated carbonation, a bulk rate of carbonation of 66.7% can be achieved throughout the entire assembly. Based upon this accelerated carbonation experimental evidence, the model assumes that, over the anticipated service life of hempcrete (^{˜}60-100 years), that sufficient carbonation will occur throughout the full depth of the assembly. Additional long-term experimental data on the rate of carbon uptake in hempcrete at ambient conditions would provide additional support for this assumption.

Studies of historic structures built with lime mortars have shown that carbonation processes halt after a degree of carbonation of 86% is obtained for thin, exposed mortars, and 75% for thick, covered mortars. Thus, while degree of carbonation is ultimately up to the discretion of the modeler, it is recommended that a degree of carbonation of 75% be used as an input for the model proposed herein (ϕ_{C}=0.75).

### Carbonation Model Implementation in Hempcrete LCA

Mix Designs

The theoretical carbonation model derived in the previous section was implemented in life cycle assessments (LCAs) of 36 theoretical hempcrete mixture designs (see Table 3). These mixtures represent conventional hempcrete mixtures. Binders include different combinations of hydrated lime (CL90-S) and three types of hydraulic binders, NHL, (OPC), and MK. Each binder combination is used to evaluate the model at three different concentrations of hydraulic or pozzolanic binder: low (20%), medium (35%), and high (50%), and at four different densities: very light (175 kg/m³), light (225 kg/m³), medium (300 kg/m³), and high (425 kg/m³), based upon common ranges for residential construction in North America. Each density of hempcrete is the result of different hemp-to-binder-to-water ratios (by mass) (see Table 4).

TABLE 3
Representative hempcrete mixture design formulations.

| | | | | | Binder Paste by Volume | | | |
|---|---|---|---|---|---|---|---|---|
| | | | | | Percent (Decimal) | | | |
| Mix | | Block | Density | Binder | HL | | OPC | |
| Number | Mix Name | Density | (kg/m³) | Types | (CL90-S) | NHL 5 | Type 1 | Metakaolin |
| 1 | NHL + High + VL | Very | 175 | HL and | 0.500 | 0.500 | — | — |
| | | Light | | NHL | | | | |
| 2 | NHL + Mid + VL | Very | 175 | HL and | 0.650 | 0.350 | — | — |
| | | Light | | NHL | | | | |
| 3 | NHL + Low + VL | Very | 175 | HL and | 0.800 | 0.200 | — | — |
| | | Light | | NHL | | | | |
| 4 | OPC + High + VL | Very | 175 | HL and | 0.750 | — | 0.250 | — |
| | | Light | | OPC | | | | |
| 5 | OPC + Mid + VL | Very | 175 | HL and | 0.825 | — | 0.175 | — |
| | | Light | | OPC | | | | |
| 6 | OPC + Low + VL | Very | 175 | HL and | 0.900 | — | 0.100 | — |
| | | Light | | OPC | | | | |
| 7 | MK + High + VL | Very | 175 | HL and | 0.500 | — | — | 0.500 |
| | | Light | | Metakaolin | | | | |
| 8 | MK + Mid + VL | Very | 175 | HL and | 0.550 | — | — | 0.450 |
| | | Light | | Metakaolin | | | | |
| 9 | ML + Low + VL | Very | 175 | HL and | 0.600 | — | — | 0.400 |
| | | Light | | Metakaolin | | | | |
| 10 | NHL + High + L | Light | 225 | HL and | 0.500 | 0.500 | — | — |
| | | | | NHL | | | | |
| 11 | NHL + Mid + L | Light | 225 | HL and | 0.650 | 0.350 | — | — |
| | | | | NHL | | | | |
| 12 | NHL + Low + L | Light | 225 | HL and | 0.800 | 0.200 | — | — |
| | | | | NHL | | | | |
| 13 | OPC + High + L | Light | 225 | HL and | 0.750 | — | 0.250 | — |
| | | | | OPC | | | | |
| 14 | OPC + Mid + L | Light | 225 | HL and | 0.825 | — | 0.175 | — |
| | | | | OPC | | | | |
| 15 | OPC + Low + L | Light | 225 | HL and | 0.900 | — | 0.100 | — |
| | | | | OPC | | | | |
| 16 | MK + High + L | Light | 225 | HL and | 0.500 | — | — | 0.500 |
| | | | | Metakaolin | | | | |
| 17 | MK + Mid + L | Light | 225 | HL and | 0.550 | — | — | 0.450 |
| | | | | Metakaolin | | | | |
| 18 | MK + Low + L | Light | 225 | HL and | 0.600 | — | — | 0.400 |
| | | | | Metakaolin | | | | |
| 19 | NHL + High + M | Medium | 300 | HL and | 0.500 | 0.500 | — | — |
| | | | | NHL | | | | |
| 20 | NHL + Mid + M | Medium | 300 | HL and | 0.650 | 0.350 | — | — |
| | | | | NHL | | | | |
| 21 | NHL + Low + M | Medium | 300 | HL and | 0.800 | 0.200 | — | — |
| | | | | NHL | | | | |
| 22 | OPC + High + M | Medium | 300 | HL and | 0.750 | — | 0.250 | — |
| | | | | OPC | | | | |
| 23 | OPC + Mid + M | Medium | 300 | HL and | 0.825 | — | 0.175 | — |
| | | | | OPC | | | | |
| 24 | OPC + Low + M | Medium | 300 | HL and | 0.900 | — | 0.100 | — |
| | | | | OPC | | | | |
| 25 | MK + High + M | Medium | 300 | HL and | 0.500 | — | — | 0.500 |
| | | | | Metakaolin | | | | |
| 26 | MK + Mid + M | Medium | 300 | HL and | 0.550 | — | — | 0.450 |
| | | | | Metakaolin | | | | |
| 27 | MK + Low + M | Medium | 300 | HL and | 0.600 | — | — | 0.400 |
| | | | | Metakaolin | | | | |
| 28 | NHL + High + H | Heavy | 425 | HL and | 0.500 | 0.500 | — | — |
| | | | | NHL | | | | |
| 29 | NHL + Mid + H | Heavy | 425 | HL and | 0.650 | 0.350 | — | — |
| | | | | NHL | | | | |
| 30 | NHL + Low + H | Heavy | 425 | HL and | 0.800 | 0.200 | — | — |
| | | | | NHL | | | | |
| 31 | OPC + High + H | Heavy | 425 | HL and | 0.750 | — | 0.250 | — |
| | | | | OPC | | | | |
| 32 | OPC + Mid + H | Heavy | 425 | HL and | 0.825 | — | 0.175 | — |
| | | | | OPC | | | | |
| 33 | OPC + Low + H | Heavy | 425 | HL and | 0.900 | — | 0.100 | — |
| | | | | OPC | | | | |
| 34 | MK + High + H | Heavy | 425 | HL and | 0.500 | — | — | 0.500 |
| | | | | Metakaolin | | | | |
| 35 | MK + Mid + H | Heavy | 425 | HL and | 0.550 | — | — | 0.450 |
| | | | | Metakaolin | | | | |
| 36 | MK + Low + H | Heavy | 425 | HL and | 0.600 | — | — | 0.400 |
| | | | | Metakaolin | | | | |

TABLE 4
Hemp-to-binder-to-water ratios for different mixture densities.

| Hempcrete | Parts | Parts | Parts |
|---|---|---|---|
| Density | Hemp | Binder | Water |
| Very Light | 1 | 1 | 1.5 |
| Light | 1 | 1.25 | 1.75 |
| Medium | 1 | 1.75 | 1.75 |
| Heavy | 1 | 2.5 | 2.25 |

### LCA Methodology

LCA Goal and Scope

Using the ISO 14040/14044 framework (ISO, 2006a, 2006b), LCAs are performed to quantify the total global warming potential (GWP) of a functional unit of hempcrete. The goal of the LCA is to implement the proposed carbonation model to understand the total carbon storage potential of hempcrete, which will be useful to building product manufacturers and building designers for use in in whole-building LCA.

The functional unit considered in this LCA is 1 m² of non-load-bearing insulation made with hempcrete cast on-site between temporary formwork. The target insulation application is desirably an insulation layer that achieves a heat transfer coefficient of 0.27 W/(m²K) (R-20). This U-value was selected to represent target thermal insulation levels specified by US residential building codes in cold climates (IECC, 2017). Thickness and, thus, total volume, of the functional unit will vary for each hempcrete mixture formulated in Table 3. While the thermal conductivity of hempcrete varies by binder type and moisture content, the simplified empirical relationship (Eq. 14) for both precast and sprayed assemblies relates λ is thermal conductivity (mW/(mK)) to density, ρ (kg/m³), of hempcrete.

λ=0.4228*ρ−42.281 (14)

Eq. 14 was used to calculate the thickness of each functional unit. The corresponding volume of the functional unit is calculated by multiplying the thickness (m) by 1 m². Because the thermal conductivity of hempcrete assembly is dependent upon the density, different mix designs result in different sized functional units. The functional unit geometries are summarized in Table 5.

TABLE 5
Thickness and total volume of 1 m² hempcrete
insulation (U-value = 0.27 W/(m²K)).

| | | Computed | | Total |
|---|---|---|---|---|
| | | Thermal | Required | Volume of |
| | | Conductivity | Thickness | Functional |
| Hempcrete | Density | (W/(mK)) | (m) | Unit (m³) |
| Very Light | 175 | 0.032 | 0.12 | 0.12 |
| Light | 225 | 0.053 | 0.20 | 0.20 |
| Medium | 300 | 0.085 | 0.31 | 0.31 |
| Heavy | 425 | 0.137 | 0.51 | 0.51 |

Referring to FIG. 1, the system boundary of the LCA includes stages A1-A3 (product, or “cradle-to-gate” stage) and B1 (use-stage) as defined by EN 15804 (EN, 2011). The product stage includes the material extraction (A1) (including biogenic carbon storage), transportation (A2), and manufacturing (A3) for both the binder and the hemp shiv. The use stage (only B1) includes the carbonation of the binder and neglects all other maintenance or repair stages. End-of-life stages (C1-C4) are ignored due to the assumption that full carbonation is achieved during the lifespan of the hempcrete assembly. Construction stages (A4-A5) and other use stages (B2-B7) are not included in the analysis, because these stages are assumed to be equivalent across all mix designs considered and thus do not support the goal of the LCA. The only environmental impact considered by the assessment is 100-year global warming potential (GWP), measured in kg of carbon-dioxide equivalent (kg CO₂e), due to its immediate importance to keep global average temperatures from increasing more than 1.5° C. (UNFCCC, 2015).

Life Cycle Inventory (LCI) Data

Life cycle inventory (LCI) data were collected from peer-reviewed literature and open-source datasets for each material constituent in the hempcrete formulations. The environmental impacts are attributional and are allocated on a per-mass basis. Table 6 summarizes the data collected, its source, quality, and suitability for this LCA. Data for hydrated lime is given “medium” reliability, given its publication date of 2010 and the fuel type of the lime kiln having a significant impact on the cradle-to-gate emissions. The rest of the data are considered to have high reliability, given that it is timely data obtained from peer reviewed LCA publications. It is assumed that data collected for specific manufacturing processes are representative of the average emissions for worldwide production. While different hemp growing practices and manufacturing processes will affect total emissions from life cycle stages A1-A3, the carbonation model presented herein could still be used to predict the carbon storage potential of hempcrete due to binder carbonation in LCA Stage B1.

This LCA assumes that biogenic carbon is stored by the hempcrete assembly for the duration of the lifespan and that the hempcrete crop is replaced within a year of harvest. Additionally, since hemp is mixed with a binder, it is not expected to decompose at the end-of-life. These assumptions simplify the need for dynamic LCA, and biogenic carbon can be counted as a benefit to the GWP of the hempcrete assembly in LCA Stage A1.

TABLE 6
LCI data for the GWP of a declared unit of each hempcrete
material constituent. Note that emissions for hemp
shiv are separated into manufacturing emissions (positive
value) and biogenic uptake (negative value).

| | A1-A3 GWP | |
|---|---|---|
| | (kg CO₂e/kg | |
| Material | material) | Reliability |
| Hydrated Lime | 1.2 | Medium |
| NHL 5 | 0.635 | High |
| Type 1 OPC | 0.912 | High |
| Metakaolin | 0.421 | High |
| Hemp Shiv | 0.104 | High |
| (Emissions) | | |
| Hemp Shiv | −1.84 | High |
| (Biogenic | | |
| Uptake) | | |
| Water | 0.003 | High |

While the chemical and morphological diversity of CSH is high, it is assumed that CSH takes the primary form of C₃S₂H₈. If the calcium-to-silicon ratio (C/S) ratio decreases over time, as it is well known to do during carbonation, the actual stoichiometric ratios in the carbonation reaction will change, affecting the coefficients of α_{CSH} and the overall estimate carbon storage results. However, the estimate for carbon storage potential via carbonation remains conservative, given that the calcium that would become available for additional carbonation during CSH destabilization and decalcification during carbonation is not accounted for in the model.

Since the model is chemistry-based (using stoichiometry), and there is ample existing research on the carbonation of other cementitious materials, this disclosure focuses on the model's value of prediction and the consequences of choosing different models to predict carbonation on the overall LCA results.

As a screening LCA, only life cycle stages A1-A3 and B1 were considered as part of the system boundary to elucidate the results between different mix designs. Additionally, the environmental impacts associated with LCA stages A4 (transportation to site) and A5 (construction) were assumed equivalent for each mix design and not considered in the LCA. Inclusion of these stages within the system boundary could, however, change the results.

Biogenic CO₂ storage is best modeled using dynamic LCA and will produce different results compared to the simplified screening LCA methodology used herein. While giving more accurate results, the use of dynamic LCA did not directly support illustrating the implementation of a new, theoretical carbonation model for hempcrete to calculate carbon storage potential in the context of total life cycle carbon emissions. However, the model presented herein can be adapted for implementation in dynamic LCA.

Full carbonation (to a degree of 0.75 as previously described) during the lifetime of the hempcrete assembly is assumed in this LCA. While others experimentally showed uptake of 7 g and 12 g of CO₂ per kilogram of binder for aerial lime and OPC assemblies, respectively, after 240 days of exposure, over the expected lifespan of buildings (60-100 years) full carbonation is expected.

### CO₂ Storage Potential via Carbonation

Effect of Binder Type

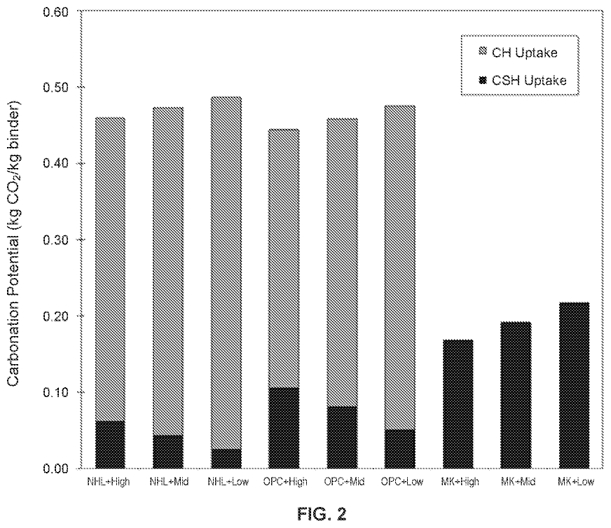

Using the proposed carbonation model, the estimated in situ carbon sequestration potential of hempcrete mixtures for each concentration of hydraulic or pozzolanic binder (High, Mid, and Low) is shown in FIG. 2. Carbonation is separated into CH and CSH carbonation to represent the mass of CO₂ per mass of binder that is stored during the carbonation process. The more hydrated lime that is available (low hydraulic or pozzolanic additive concentration), the higher the total carbon uptake across all mixtures. For mixtures with hydraulic binders (NHL and OPC), for example, the carbon uptake through CH carbonation dominates the carbon uptake through the carbonation of CSH. For example, as shown in FIG. 2, the NHL+Mid mixtures have an estimated carbonation potential of 0.47 kg CO₂/kg binder, where 0.43 kg CO₂/kg binder is achieved via carbonation of CH and 0.04 kg CO₂/kg binder is achieved via carbonation of CSH. Additionally, as less hydraulic binder is used, less CSH is produced and, therefore, less CSH is available to carbonate. Contrastingly, more CH is available from the slaked lime, thereby increasing the carbonation potential. Due to OPC containing more silica than NHL, much of the available calcium oxides (i.e., C₂S and C₃S) are converted not only to CH but also to CSH (see Eq. 1 and Eq. 2), which results in a higher carbon uptake from CSH carbonation, as expected. Mixes that utilize NHL as a hydraulic binder correspond to the highest carbonation potential due to the highest amounts of calcium oxide available.

In comparison to mixtures with hydraulic binders, mixtures with metakaolin (a pozzolan) exhibit much lower carbonation potentials per mass of binder, as expected. In these mixtures, CH is consumed in pozzolanic reactions (Eqs. 5 and 6), which results in no CH available for carbonation. Therefore, total carbonation potential equals the total theoretical uptake by CSH alone. As observed for the hydraulic binder mixtures, as the concentration of metakaolin decreases, the total carbon uptake decreases. At the low concentrations of pozzolanic additive, more hydrated lime is present in the mixture that is converted to CSH, which is subsequently available to carbonate. If silica (S) is the limiting reagent, some CH would be unconsumed after the pozzolanic reactions, which would result in some CH carbonation. High concentrations of pozzolanic mixtures would elucidate this result, yet these proportions are not conventionally used in residential hempcrete construction.

Effect of Density

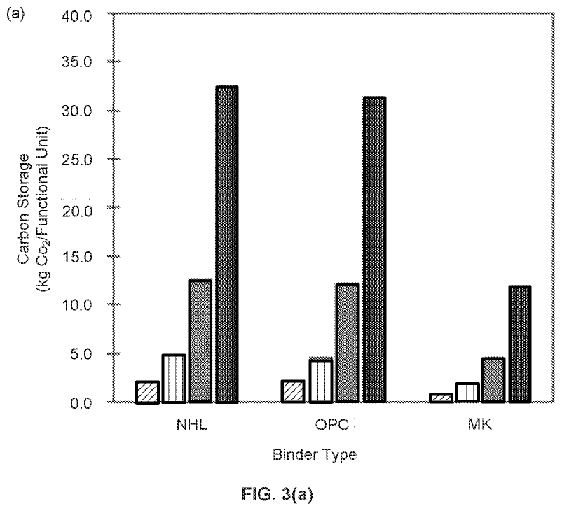

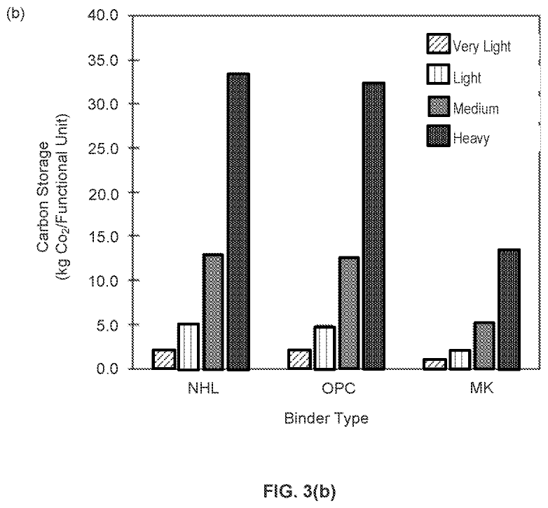

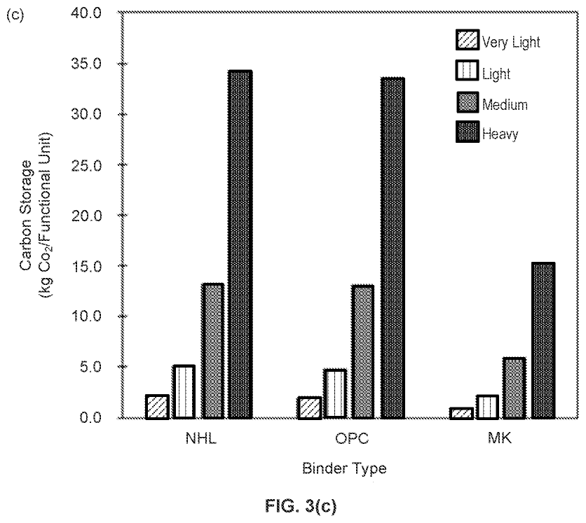

The target density of a hempcrete mixture influences the total amount of binder. FIG. 3 compares the theoretical carbon uptake via carbonation (B1) per functional unit of different hempcrete mixtures across different target densities. Note that the carbon storage potential in FIG. 3 is represented by positive (rather than negative) values. As expected, higher-density mixtures exhibit higher propensities for carbon uptake via carbonation due to the higher amounts of binder required to create the functional unit. For example, functionally equivalent very light, light, medium, and heavy NHL mixes with medium concentration of hydraulic binders have binder masses of 5.87 kg, 13.76 kg, 36.54 kg, and 94.04 kg, respectively, corresponding to estimated carbon uptake via carbonation of 2.1 kg CO₂, 4.9 CO₂, 12.9 CO₂, and 33.3 CO₂, respectively.

These results, as well as those presented in FIG. 2, illustrate that the theoretical carbon storage potential of hempcrete via in situ carbonation is proportional to the mass of binder, as anticipated. Thus, increasing the mass of the binder (i.e., higher-density mixtures) increases the total estimated carbon uptake via carbonation. Heavy density mixtures contain ^{˜}10 times the mass of binder compared to very light mixtures, which results in higher carbon sequestration potential estimates per functional unit.

Comparison of Carbonation Models

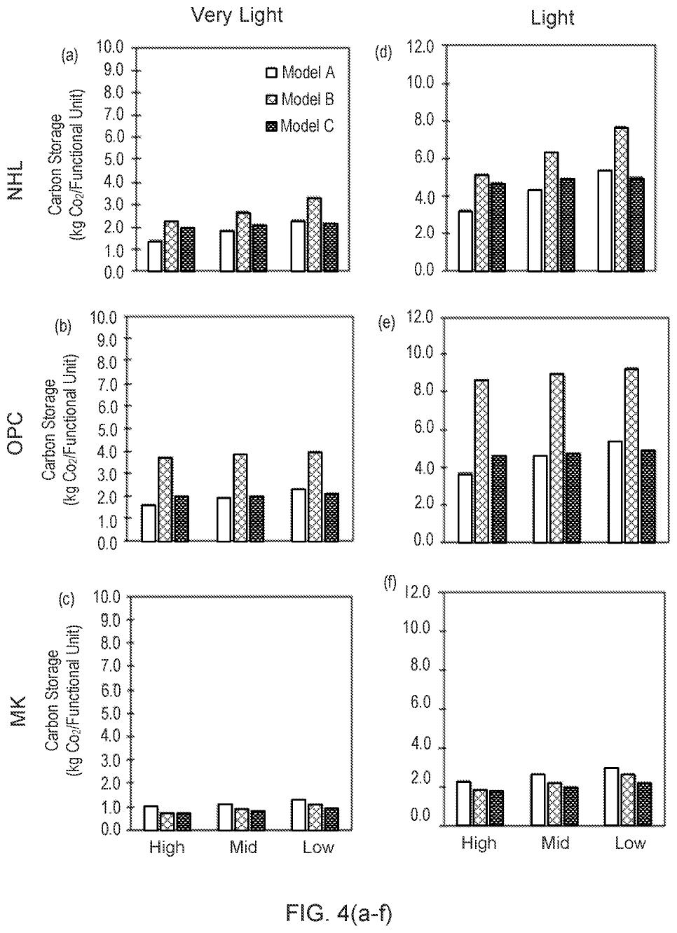

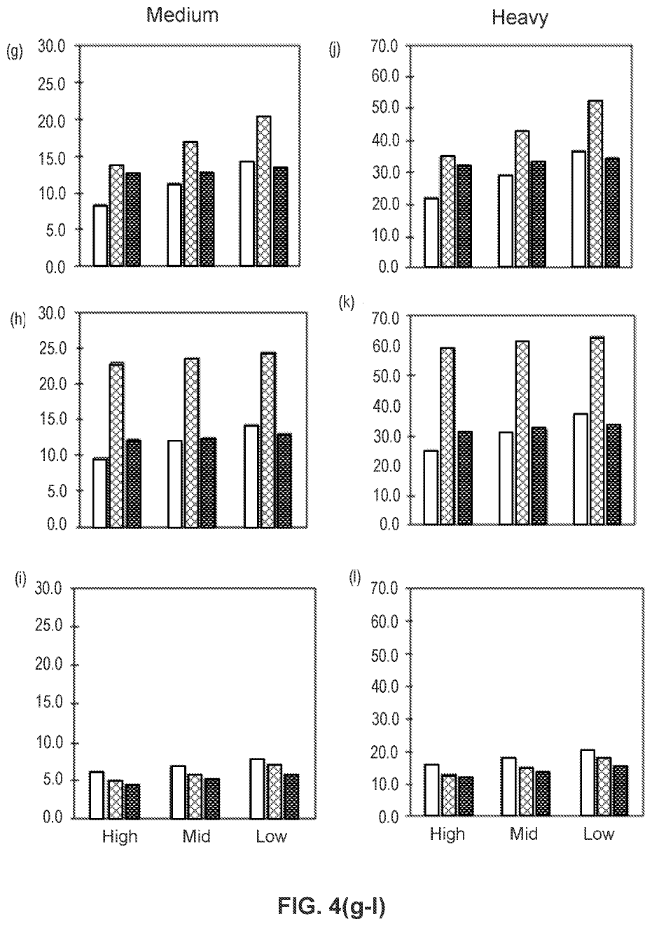

The two models identified in the literature (Model A and Model B), along with the model proposed herein (Model C), were used to estimate the theoretical carbon uptake via carbonation of all mix designs in FIG. 4. As previously discussed, Model A only considers carbonation of the hydrated lime, while Model B considers the carbonation of all CH. Model C considers carbonation of the available CH and CSH from a cement and carbonation chemistry perspective and accounts for the use of multiple binders and pozzolanic additives.

As evidenced by the comparative estimates in FIG. 4, Model B provides higher estimates of the carbon storage potential of hempcrete via carbonation as compared to Model A and Model C for mixtures containing NHL and OPC. For example, for the medium density, high-concentration NHL mixture (mix number 19), Models A, B, and C predict carbon storage of 8.5 kg CO₂/FU, 13.7 kg CO₂/FU, and 12.6 kg CO₂/FU respectively. For the high-concentration NHL mixtures, Model A provides lower estimates of CO₂ uptake via carbonation compared to Model C, since it does not consider the presence of calcium oxides in the hydraulic binder. Model B provides higher estimates of CO₂ uptake compared to Model C, since it assumes 75% of all available CaO converts to CH, neglecting the formation of CSH and its associated carbonation potential. The tendency for Model B to provide higher estimates of CO₂ is most evident for the mixtures containing OPC (FIG. 4 (b), (e), (h), and (k). Since OPC contains more silicates, it produces more CSH than mixtures with NHL. For the medium density, high-concentration OPC mix (mix number 22), Model B predicts a carbon uptake through carbonation of 23.0 kg CO₂/FU as compared to the 12.2 kg CO₂/FU prediction of Model C—an increase of ^{˜}90%. The difference between these two models illustrates how different models for carbonation can lead to different results.

For mixtures with MK, Model A and Model B provide higher estimates of carbon uptake compared to Model C. For the medium density, low-MK mixture (mix number 27), Model A predicts 7.0 kg CO₂/FU, Model B predicts 5.9 kg CO₂/FU, and Model C predicts 5.2 kg CO₂/FU. Due to the presence of pozzolans (a source of silica), Model C accounts for hydrated lime that is fully consumed to produce CSH. Models A and B neglect formation of CSH, which results in higher estimates of carbon uptake.

### LCA Results

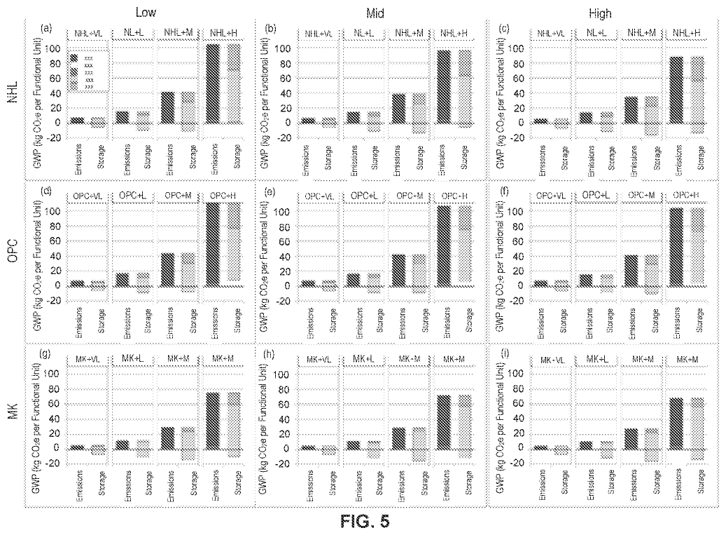

CO₂ uptake via binder carbonation (Stage B1) is only one component of the life cycle emissions of a hempcrete assembly. FIG. 5 illustrates the carbon storage potential of hempcretes in relation to total life cycle emissions for hydraulic and pozzolan binder hempcrete mixtures for different densities. The vertical axis represents the GWP (kgCO₂e) per functional unit, where negative values correspond to carbon storage and positive values correspond to carbon emissions. For each mixture, the processes associated with carbon emissions are plotted on the left (A1-A3), and storage (both biogenic and carbonation) on the right. The net difference between the left and right columns is an estimate of total life-cycle emissions. For example, in FIG. 5(a), the heavy density mixtures (NHL+H) has two columns, emissions on the left and storage on the right. The emissions are associated with hemp, binder, and water production, totaling to 105.09 kg CO₂e. The carbon storage through both carbonation and biogenic uptake is −103.46 kg CO₂e. Thus, the net emissions of the NHL+Low+H mixture (Mix 30) are positive (indicating Mix 30 is a net CO₂ emitter), of 1.63 kg CO₂e and are represented by the bottom of the right bar. If the bottom of the right column is below zero, the hempcrete functional unit has negative net-emissions. If it is above zero, the hempcrete functional unit has positive net-emissions.

As anticipated, initial CO₂ emissions are dominated by binder production. Hemp production contributes small quantities of cradle-to-gate emissions. Emissions associated with water use are negligible (<0.55% of total emissions). Binder manufacturing represents the largest contributor to the life cycle emissions as a result of the calcination process required to produce hydrated lime and hydraulic binders. Across all mixture types, increasing density increases binder mass and, thus, emissions associated with manufacture. MK-containing mixtures (FIGS. 5(g), (h), and (i)) exhibit lower emissions from the binder, since the manufacturing process for metakaolin is less energy and emissions intensive. However, as explored previously, the carbon uptake through carbonation for the mixtures with metakaolin is lower than those with hydraulic binders.

The results illustrate that 18.5-38.4% of initial emissions from binder production can be recovered through the carbonation process. However, high carbonation potential of the binder does not necessarily correspond to the mix design with the most carbon storage per functional unit. For NHL (FIGS. 5 (a), (b), and (c)), the medium density, high-concentration mix design (Mix 19) exhibits the lowest total carbon emissions, −15.95 kg CO₂e/FU, as compared to the other NHL mixtures. However, that mix has −12.60 kg CO₂/FU of carbon stored through carbonation, which is significantly less than the high-concentration NHL heavy density mixture (Mix 28), which has an estimated carbon uptake through carbonation of— 32.42 kg CO₂/FU. This finding is similar to previous work by the authors, which showed significant carbon uptake—but overall higher net carbon emissions—of OPC concrete and pervious concrete mixtures with high cement contents.

The amount of biogenic carbon stored for each mix design is shown in FIG. 5. The amount of hemp shiv in each mix is directly proportional to the target mix density. Hence, when the biogenic carbon coefficient of −1.84 kg CO₂/kg hemp shiv is applied, the amount of carbon stored increases.

Nearly all mix designs result in net carbon storage during their life cycle. The mix designs that maximize carbon storage of the hempcrete assembly are the NHL+High+M (Mix 19), MK+High+M (Mix 25), and MK+Mid+M (Mix 26) mixtures with a life cycle GWP of −15.95 kg CO₂e/FU, −15.86 kg CO₂e/FU, and −15.19 kg CO₂e/FU respectively. Nearly all MK-based mixtures outperform their hydraulic binder counterparts due to the carbon intensity of manufacturing hydraulic binders.

While hempcrete is often deemed a carbon-negative material, not all mix designs considered herein result in net storage. The heavy density (425 kg/m³) low-concentration OPC-containing mixtures, for example, showed a positive GWP (8.16 kg CO₂e/FU) after all storage components were considered. Heavy density mixtures are often considered for semi-structural applications, yet, depending on the mixture design, the hempcrete assembly may not store carbon and another functionally equivalent insulation material may have lower carbon emissions.

### Effect of Carbonation Model Selection on LCA Results

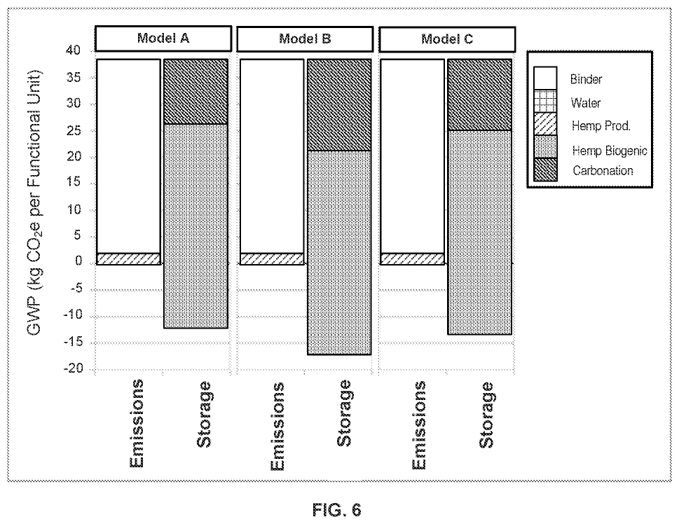

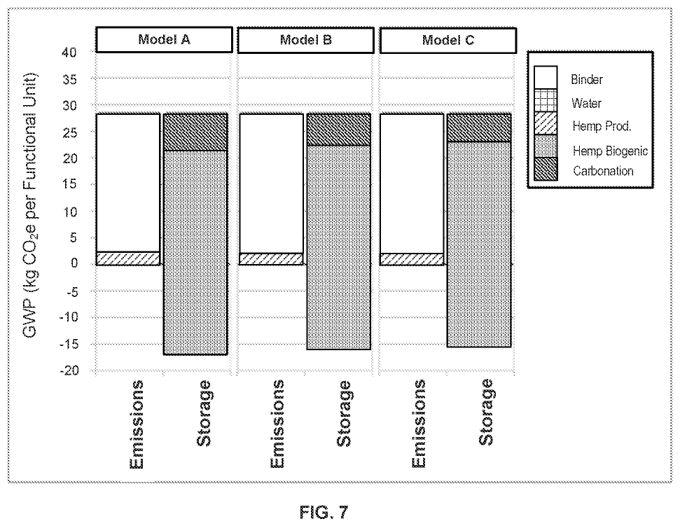

Each of the carbonation models that have been proposed in the literature (Model A and Model B) and the model proposed herein (Model C) are implemented to evaluate how model choice impacts LCA results. FIG. 6 and FIG. 7 present the life cycle emissions calculated with each model for the mid-concentration, medium density NHL mix design (Mix 20) and the mid concentration, medium density MK mix design (Mix 26), respectively. For the selected NHL mix design, the total GWP ranges from −11.56 kg CO₂e/FU (Model A), −17.00 kg CO₂e/FU (Model B), and −13.15 kg CO₂e/FU (Model C). A manifestation of the results observed in FIG. 4, Model A and Model B provide more and less conservative estimates of total emissions in comparison to Model C, respectively.

For the MK mix design (see FIG. 7), both Model A (GWP=−16.94 kg CO₂e/FU) and Model B (GWP=−15.84 kg CO₂e/FU) provide higher estimates of total carbon storage potential compared to Model C (GWP=−15.19 kg CO₂e/FU). This result is attributable to the pozzolanic reactions that are accounted for in Model C (Eq. 5 and Eq. 6), which are not considered by either Model A or Model B. The differences in life cycle GWP as calculated by different carbonation models highlights the importance of model choice, since not accounting for the pozzolanic reactions provides an overestimation of the carbon storage potential of hempcrete.

As opposed to other models, the hempcrete carbonation model described herein (Model C) is comprehensive in that it accounts for all hydration and pozzolanic binder reactions in addition to the carbonation of both CH and CSH. The model can be applied to hempcrete mix designs of various densities and binder constituents, including pozzolans, for which previous models did not account. While most mix designs show net-negative carbon emissions (net storage), mix designs with high densities show positive life cycle emissions.

In summary, to better predict the carbon storage potential of hempcrete, a formulation and implementation of a mathematical model based on the stoichiometry of hydration, pozzolanic, and carbonation reactions is presented herein. The model was implemented in a screening LCA of 36 hempcrete mixture designs to quantify the life cycle GWP of a functional unit (1 m² of wall with a U-value of 0.27 W/(m²K)).

Key findings include:
The more calcium oxide present in the binder before hydration, the higher the carbonation potential on a per-mass-of-binder basis. However, maximizing carbonation potential does not necessarily correspond to maximizing total carbon storage of a functional unit of hempcrete.
The carbonation model formulated herein estimates between 18.5% and 38.4% of initial emissions from binder production can be sequestered through the carbonation process. When biogenic carbon storage is also considered, net emissions of −13.15 kg CO₂e/m² are predicted when hydraulic binders are used (mid-concentration, medium density NHL mixture) and net emissions of −15.84 kg CO₂e/m² when pozzolanic binders are used (mid-concentration, medium density metakaolin mixture). Mix designs that use metakaolin (a pozzolan), while not maximizing carbon storage via carbonation, minimizes total life cycle GWP and carbon storage due to lower initial emissions associated with binder production.
High-density mixtures (425 kg/m³), often used for their higher strengths, do not maximize carbon storage. In fact, when OPC is used as a hydraulic binder in high-density mixtures, results illustrate that hempcrete assemblies could be a net CO₂ emitter (up to 8.16 kg CO₂e/FU).

The model formulated and implemented in this disclosure confirms that many hempcrete mixture designs in accordance with examples of the disclosure exhibit net-negative carbon emissions (i.e., carbon storage). The results suggest that low-density, natural hydraulic binder mixtures are key to maximizing the carbon-storage potential of hempcrete. This work also illustrates how the chemistry-based carbonation model can be used in combination with LCA to estimate the carbon-storage potential of hempcrete in achieving low-carbon building design objectives.

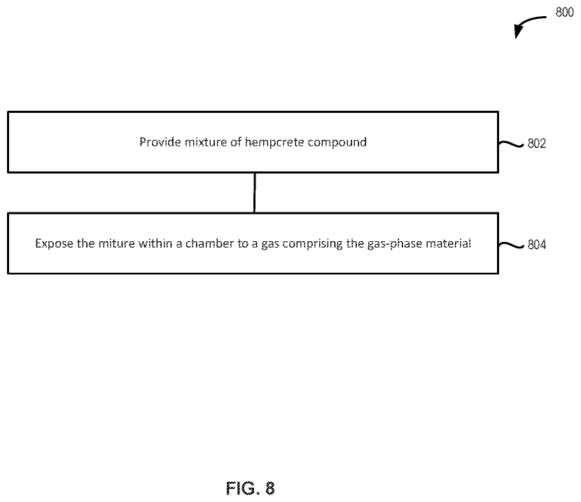

Referring to FIG. 8, in accordance with examples of the disclosure, a method 800 of sequestering gas-phase materials includes providing a mixture of hempcrete compound material within a chamber (step 802) and exposing the mixture within the chamber to a gas comprising the gas-phase materials for a period of time to form hempcrete (step 804). In accordance with various aspects of these embodiments, the hempcrete formed according to method 800 exhibits a net negative life cycle carbon emission.

During step 802, a mixture of hempcrete compound material is provided within a chamber. The mixture can include any suitable mixture, such as the mixtures described herein, and may be suitably selected, as noted herein, to provide a net negative life cycle carbon emission. By way of examples, the mixture of hempcrete compound material includes a binder and (e.g., fibrous) material. For example, the mixture can include lime, fly ash, slag, cement, or other cementitious material.

The binder can include hydrated lime and one or more of a hydraulic (e.g., natural hydraulic lime and/or ordinary portland cement) or pozzolanic binder (e.g., metakaolin). An amount of binder in the mixture can be greater than or equal to 30 wt %, is greater than or equal to 40 wt %, or is greater than or equal to 50 wt %. For example, the amount of binder in the mixture can range from about 20 to about 90 or about 40 to about 70 wt %. Exemplary mixtures can include about 20 to about 95 or about 50 to about 70 wt % hydrated lime, about 20 to about 95 or about 50 to about 70 wt % hydraulic binder (e.g., natural hydraulic lime and/or ordinary portland cement), and/or about 20 to about 95 or about 50 to about 70 wt % pozzolanic binder, such as natural and/or artificial pozzolan (e.g., metakaolin). The mixture can also include about 20 to about 95 or about 50 to about 70 wt % slag, which can be a binder or an additional additive.

The (e.g., fibrous) material can include one or more of hemp shiv, hemp fiber, rice husk (hulls), flax shiv, and/or rapeseed. Additionally or alternatively, the material can include agricultural waste, such as sunflower stalks, tobacco stalks, bagasse fiber, or almond (or other) shell flour. Additionally or alternatively, the material can include biochar, wood fiber, and/or plant fiber. The mixture can include about 5 to about 95 or about 40 to about 60 wt % fiber material, which can include any suitable combination of these materials.

During step 804, the mixture within the chamber is exposed to a gas comprising the gas-phase materials for a period of time to form hempcrete. The gas, including the gas-phase materials to be sequestered, can be or include, for example, one or more of flue gas, direct capture gas from cement production, carbon capture from bioenergy production, other industrial point-source carbon emissions, or the like. The period of time can range from about 1 to about 180 or about 7 to about 14 days. Step 804 can include carbonizing the mixture.

As set forth above, hempcrete formed in accordance with examples of the disclosure can include any of the compositions and/or properties noted herein. Exemplary hempcrete can exhibit desirable properties, which can be evaluated using a model, such as Model C described herein. For example, the negative net life cycle carbon emission of the hempcrete can be about −42 kg CO₂e/m³ or less (more negative) or about −51 kg CO₂e/m³ or less (more negative).

A density of the hempcrete can vary according to desired application and/or desired negative net life cycle carbon emission. For example, a density of the hempcrete can be between about 200 kg/m³ and about 600 kg/m³ or greater than 225 kg/m³ and less than 425 kg/m³.

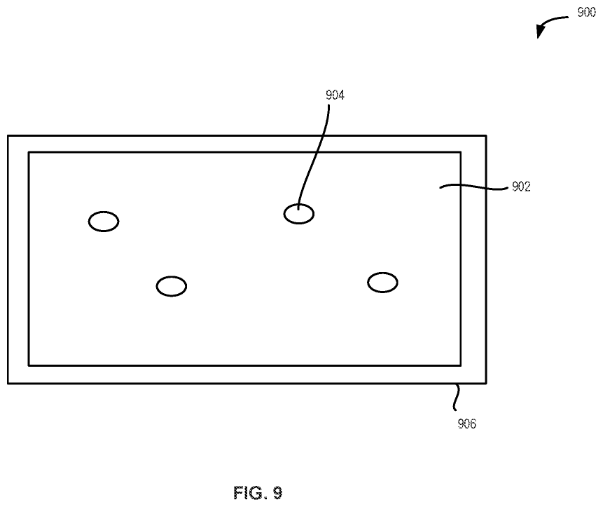

In some cases, the mixture or hempcrete can further include a substance to decrease a thermal conductivity of the hempcrete. For example, the mixture or the hempcrete can include a phase change material, such as a paraffin or polyethylene glycol. In such cases, the mixture or hempcrete can include about 0 to about 30 or about 2 to about 20 wt % phase change material. Additionally or alternatively, the mixture or hempcrete can include artificially-created voids. The artificially-created voids can be formed using, for example, thin-membrane balloons or encapsulants (e.g., filled with air). Such balloons or encapsulants or artificial voids can be present in the mixture or hempcrete in an amount of about 0 to about 95 or about 10 to about 30 volume %. Additionally or alternatively, the mixture or hempcrete can include expanded aggregate, such as perlite, fumed silica, or chert. The expanded aggregate can be present in the mixture or hempcrete in an amount of about 0 to about 95 or about 10 to about 30 volume %. FIG. 9 illustrates a block of hempcrete 900, including bulk hempcrete material 902, and a substance or artificially-created voids 904 (e.g., phase change material, artificially-created voids, expanded aggregate, or the like).

In accordance with further examples, the mixture can be encapsulated in a thin-membrane material, such as plastic or other impermeable barrier and exposed to the gas within the thin-membrane material. After carbonization, the hempcrete can be exposed to a vacuum, and the thin-membrane material can be sealed, such that the hempcrete is sealed under a vacuum. Additionally or alternatively, hempcrete (e.g., one or more blocks of hempcrete) can be encased in an encapsulating material 906, such as plastic or other impermeable barrier. The encapsulated hempcrete can then be exposed to a vacuum and encapsulating material 906 sealed, such that the hempcrete is packed under a vacuum (e.g., less than 760 Torr or about 10⁻⁶ to about 1 Torr).

Methods in accordance with examples of the disclosure can further include spraying the hempcrete onto a surface or a substrate and/or forming prefabricated blocks or panels of hempcrete. Methods of using the hempcrete as described herein can include use of the hempcrete in construction of a building.

The example embodiments of the disclosure described above do not limit the scope of the invention, since these embodiments are merely examples of the embodiments of the invention, which is defined by the appended claims and their legal equivalents. Any equivalent embodiments are intended to be within the scope of this invention. Indeed, various modifications of the disclosure, in addition to those shown and described herein, such as alternative useful combinations of the elements (e.g., steps) described, may become apparent to those skilled in the art from the description. Such modifications and embodiments are also intended to fall within the scope of the appended claims. Further, the claims provided below form part of the disclosure of the invention.

1. A method of sequestering gas-phase materials, the method comprising the steps of:
providing a mixture of hempcrete compound material within a chamber; and
exposing the mixture within the chamber to a gas comprising the gas-phase materials for a period of time to form hempcrete,
wherein the hempcrete exhibits a net negative life cycle carbon emission.

2. The method of claim 1, wherein the step of exposing comprises carbonizing the mixture.

3. The method of claim 1, wherein the mixture comprises agricultural waste.

4. The method of claim 1, wherein the mixture comprises one or more of hemp shiv, hemp fiber, rice husk (hulls), flax shiv, and/or rapeseed.

5. The method of claim 1, wherein the mixture comprises one or more of biochar, wood fiber, and/or plant fiber.

6. The method of claim 1, wherein the mixture comprises slag.

7. The method of claim 1, wherein the negative net life cycle carbon emission is about −42 kg CO2e/m3 or less (more negative).

8. The method of claim 1, wherein the negative net life cycle carbon emission is about −51 kg CO2e/m3 or less (more negative).

9. The method of claim 1, wherein the gas comprises one or more of flue gas, direct capture gas from cement production, and carbon capture from bioenergy production.

10. The method of claim 1, wherein the mixture comprises natural or artificial pozzolan.

11. The method of claim 1, wherein the mixture comprises metakaolin.

12. The method of claim 1, wherein the hempcrete exhibits a density of about 200 kg/m3 to about 600 kg/m3.

13. The method of claim 1, wherein the hempcrete comprises a binder comprising hydrated lime.

14. The method of claim 1, wherein the hempcrete comprises a binder comprising natural hydraulic lime.

15. The method of claim 1, wherein an amount of binder in the mixture is greater than or equal to 30 wt %, is greater than or equal to 40 wt %, or is greater than or equal to 50 wt %.

16. The method of claim 1, wherein a density of the hempcrete is greater than 225 kg/m3 and less than 425 kg/m3.

17. The method of claim 1, wherein the hempcrete is in the form of prefabricated blocks or panels.

18. The method of claim 1, further comprising a steps of encapsulating the hempcrete and applying a vacuum to the encapsulated hempcrete.

19. Hempcrete formed according to the method of claim 1.

20. The hempcrete of claim 19, further comprising a substance selected from one or more of a phase change material, an expanded aggregate, and a thin-membraned balloon.

21. A method of using the hempcrete of claim 17 in the construction of a building.
